(19) United States
(12) Patent Application Publication
(10) Pub. No.: US 2009/0249946 A1
(43) Pub. Date: Oct. 8, 2009

(54) ELECTRIC GUITAR

(76) Inventor: William J. Hunter, Rochester Hills, MI (US)

Correspondence Address: GIFFORD, KRASS, SPRINKLE,ANDERSON & CITKOWSKI, P.C, PO BOX 7021, TROY, MI, 48007-7021, US

(21) Appl. No.: 12/413,839

(22) Filed: Mar. 30, 2009

Related U.S. Application Data
(60) Provisional application No. 61/042,062, filed on Apr. 3, 2008.

(51) Int. Cl. G10H 3/18

(52) U.S. Cl. 84/726

(57) ABSTRACT

An electric guitar having a body with a cavity formed in the body. A mounting ring is attached to the body around the cavity. At least one sound pickup is positioned in the cavity and the sound pickup is secured to the mounting ring at a user selected location.

### CROSS REFERENCE TO RELATED APPLICATIONS

This application claims priority of U.S. Provisional Patent Application Ser. No. 61/042,062 filed Apr. 3, 2008, which is incorporated herein by reference.

### BACKGROUND OF THE INVENTION

I. Field of the Invention

The present invention relates generally to stringed electric instruments, such as electric guitars.

II. Description of Related Art

Many stringed instruments, such as electric guitars, utilize sound pickups mounted to the body of the stringed instrument to detect vibration of the strings. The sound pickups are then electrically connected to amplifiers which then reproduce the sound of the vibrating strings. Such stringed instruments include, for example, electric guitars.

In a typical electric guitar, at least one, and more typically two or three sound pickups are mounted to the guitar body beneath the strings. The sound pickups are spaced apart from each other longitudinally with respect to the direction of the guitar strings. As such, the magnitude of the vibration of a plucked guitar string will vary from one sound pickup to the next.

A selector switch, typically mounted to the guitar body, selects between the different sound pickups in the guitar body as well as different combinations of the sound pickups. Since the actual tonal quality of the plucked string will vary from one sound pickup to the next, the guitar player is able to select the proper pickup for the particular type of music currently played by the musician.

Although the musician may switch from one sound pickup to another through the selector switch, the actual sound pickups mounted to the guitar body are fixed in position. Consequently, it has not been possible with these previously known guitars for the musician to adjust the position of the individual sound pickups in order to accommodate the musician's playing style or taste.

### SUMMARY OF THE PRESENT INVENTION

The present invention provides an electric guitar which overcomes all of the above-mentioned disadvantages of the previously known devices.

In brief, the electric guitar of the present invention includes a guitar body having a cavity formed in the body. A mounting ring is then attached to the body so that the mounting ring extends around the cavity. Any conventional means, such as screws, may be used to secure the mounting ring to the body.

At least one, and preferably several, sound pickups are then positioned in the cavity. These sound pickups are then secured to the mounting ring at a user selected location. As such, the actual sound detected by the sound pickups may be adjusted to accommodate the guitar player's individual taste or style.

In the preferred embodiment of the invention, the mounting ring includes two elongated slots along opposed sides of the cavity. These sound pickups are then secured to the mounting ring by a fastener, such as a pair of bolts and nuts, so that one bolt or nut extends through each end of the sound pickup and through the slot in the mounting ring. The actual position of the attachment between each end of the sound pickup and the mounting ring is infinitely variably adjustable by the user by simply sliding the sound pickup to the desired position along the mounting ring slot. Preferably, a compression spring between the nut and the mounting ring around each fastener allows the musician to slide the ends of the sound pickups along the slot in the mounting ring to the desired position. Upon release, the spring secures its associated end of the sound pickup to the mounting ring at the user selected position.

### BRIEF DESCRIPTION OF THE DRAWING

A better understanding of the present invention will be had upon reference to the following detailed description, wherein like reference characters refer to like parts throughout the several views, and in which:

FIG. 1 is a top plan view of a preferred embodiment of the invention;

FIG. 2 is a sectional view taken along line 2-2 in FIG. 1 and enlarged for clarity;

FIG. 3 is a top plan view of the preferred embodiment of the invention;

FIG. 4 is an exploded elevational view of the preferred embodiment of the invention;

FIG. 5 is an exploded elevational view illustrating the template; and

FIG. 6 is a view showing the transfer of the pickup positions to a template.

### DETAILED DESCRIPTION OF A PREFERRED EMBODIMENT OF THE PRESENT INVENTION

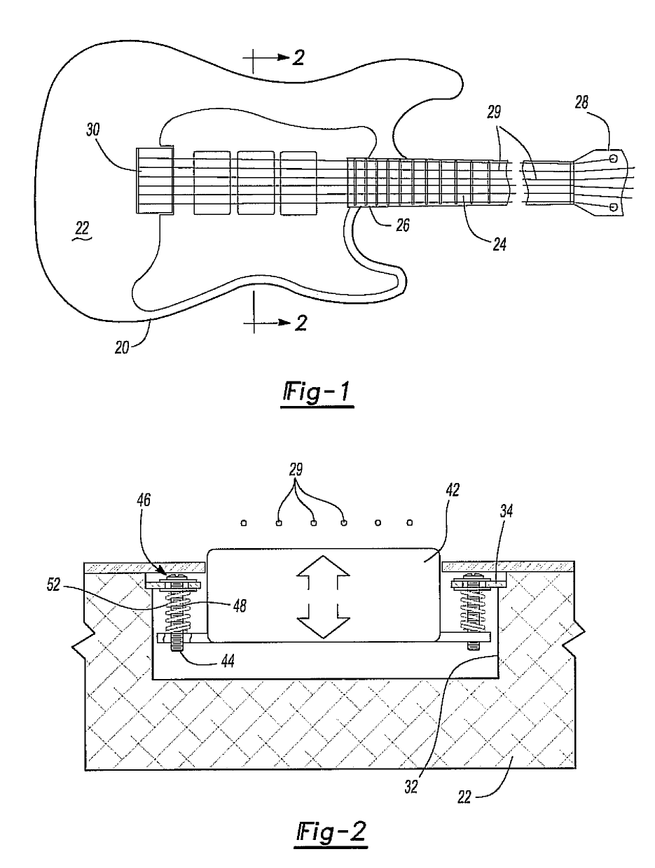

With reference first to FIG. 1, a preferred embodiment of an electric guitar 20 according to the present invention is shown. The electric guitar 20 includes a body 22 which is typically made of solid wood, although other materials may also be used.

An elongated neck 24 has one end 26 secured to the body 22 and a second end 28 spaced from the body. A plurality of strings 29 then extend under tension from the end 28 of the neck 24 and to a string retainer 30 mounted to the body 22.

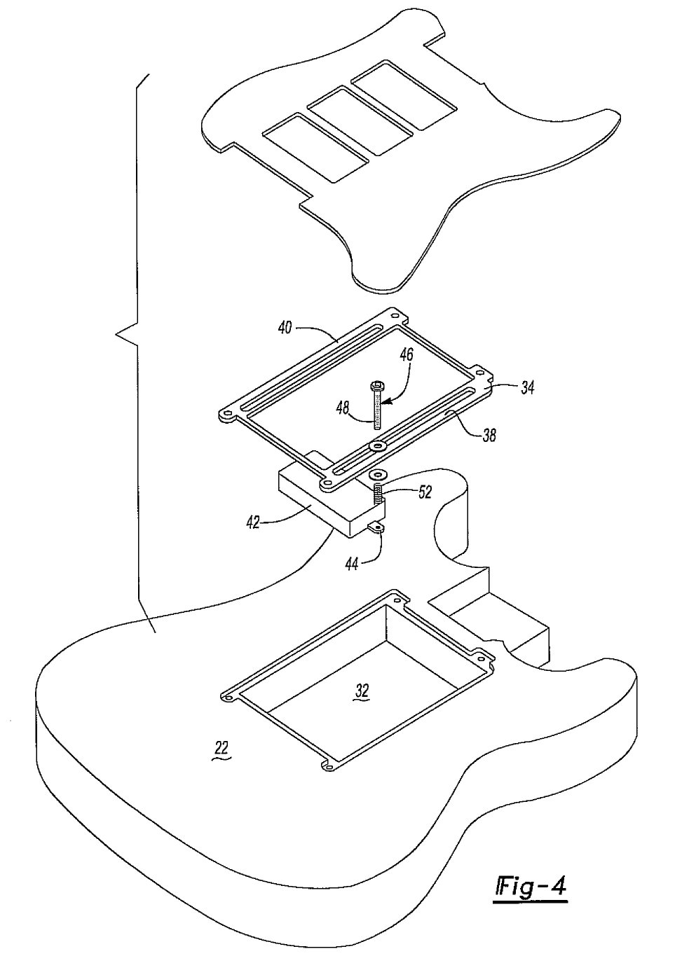

With reference to FIGS. 2-4, the body 20 includes a cavity 32 which extends under the strings 29. This cavity 32 is preferably rectangular in shape.

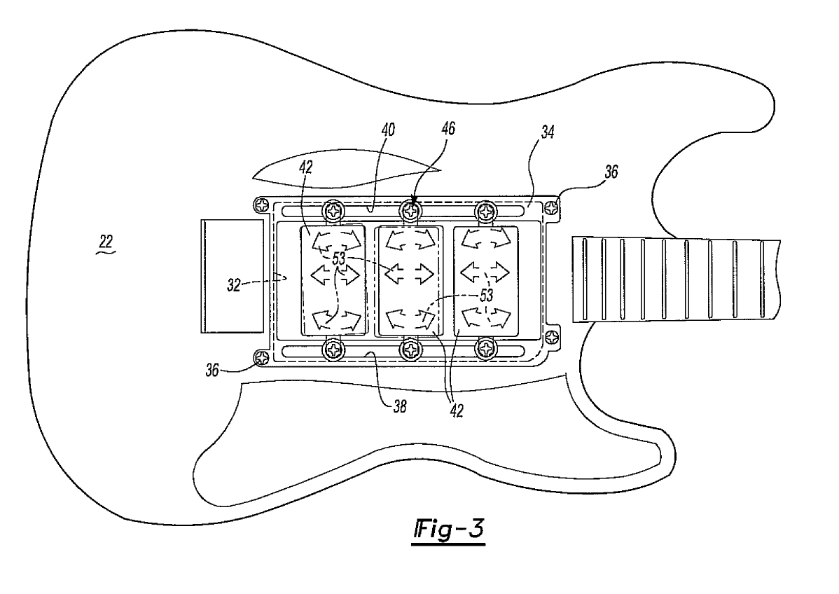

A mounting ring 34, preferably made of metal or other rigid material, is secured to the body 22 around the cavity 32. Any conventional fasteners, such as screws 36 (FIG. 3), may be used to secure the mounting ring 34 to the body 22.

The mounting ring 34 includes a first elongated slot 38 which extends along one side of the cavity 32 in the direction of the strings 29, as well as a second elongated slot 40 which extends along the opposite side of the cavity 32. The slots 38 and 40 are preferably parallel to each other.

With reference still to FIGS. 2-4, at least one, and preferably two or more sound pickups 42 are positioned within the cavity 32. Each sound pickup 42, furthermore, includes a mounting hole 44 at each end of the sound pickup 42. These mounting holes 44, furthermore, register with the slots 38 and 40 in the mounting ring.

A fastener assembly 46 is then used to secure the sound pickup to the mounting ring 34 at a user selected position along the mounting ring 34. Preferably, the fastener assembly 46 includes a bolt 48 which extends through the associated slot 38 or 40 on the mounting ring 34 and threadably engages the mounting holes 44 in the sound pickup 42. A compression spring 52 is sandwiched in between the sound pickup 42 and the mounting ring 34 around the slot 38 or 40. This compression spring 52 thus allows the musician to slide the sound pickup 42 along the slots 38 and 40 of the mounting ring 34 to the desired position as shown by arrows 53 in FIG. 3. The compression spring 52, however, then resiliently retains the sound pickup 42 at the user selected position following the adjustment.

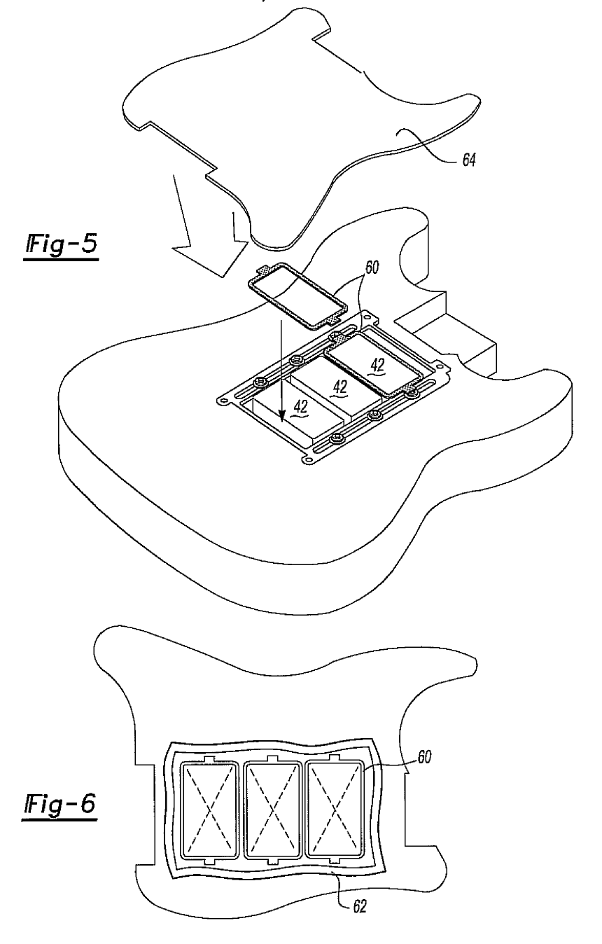

With reference now to FIGS. 5 and 6, once the sound pickups 42 have been adjusted to the desired position by the musician, the musician then optionally may create a template of the position of the sound pickups 42. For example, a template 60 may be positioned over each sound pickup 42 and the position of the template 60 may then be transferred to a template plate 62 by using a double-sided tape. The double-sided tape adhesively secures the templates 60 to the template plate 62.

The position of the template 60 on the template plate 62 may then be transferred to paper or other media. If desired, a pick guard 64 may be customized by forming openings through the pick guard that correspond to the pattern obtained from the template 60 and template plate 62. The pick guard is then secured to the body 22 in any conventional fashion thus locking the sound pickups 42 at their user adjusted positions.

From the foregoing, it can be seen that the present invention provides a novel electric guitar with sound pickups that are set at user selected locations. Furthermore, it will be understood that, although the instrument 20 illustrated in the drawing has been referenced as a guitar, the instrument 20 may be any stringed electric instrument.

Having described my invention, many modifications thereto will become apparent to those skilled in the art to which it pertains without deviation from the spirit of the invention as defined by the scope of the appended claims.

I claim:

1. An electric stringed instrument comprising:
a body having a cavity formed therein,
a mounting ring attached to said body around said cavity,
at least one sound pickup positioned in said cavity, said sound pickup being secured to said mounting ring at a user selected location.

2. The invention as defined in claim 1 wherein said mounting ring includes spaced apart slots adjacent opposite sides of said mounting ring, a first end of said sound pickup being secured to one slot by a first fastener and a second end of said sound pickup being secured to the other slot by a second fastener, each fastener being adjustably positioned along its associated slot.

3. The invention as defined in claim 2 wherein said first and second fastener each comprise a threaded bolt and nut, each bolt extending through its associated end of said sound pickup and one of said slots.

4. The invention as defined in claim 3 and comprising a pair of compression springs, one compression spring being disposed between each nut and said mounting ring.

5. The invention as defined in claim 1 wherein said mounting ring is made of metal.

6. The invention as defined in claim 1 wherein said mounting ring is secured to said body by screws.

7. The invention as defined in claim 1 and comprising at least two sound pickups positioned in said cavity and secured to said mounting ring.

8. The invention as defined in claim 1 wherein said stringed instrument includes an elongated neck having a first end secured to said body and a second end spaced from said body, and a plurality of strings, each string having one end secured to said body and a second end secured to said second end of said neck, each string having a portion extending over said at least one sound pickup.

9. The invention as defined in claim 1 wherein said instrument is a guitar.
